(19) United States
(12) Patent Application Publication
(10) Pub. No.: US 2009/0210901 A1
(43) Pub. Date: Aug. 20, 2009

(54) Targeted content delivery system in an interactive television network

(76) Inventors: William J. Hawkins, Longboat Key, FL (US); Laszlo Borsy, Debrecen (HU)

Correspondence Address: ALLEN D. BRUFSKY PA, 475 GALLEON DR., NAPLES, FL, 34102, US

(21) Appl. No.: 12/321,791

(22) Filed: Jan. 26, 2009

Related U.S. Application Data
(62) Division of application No. 10/375,028, filed on Feb. 28, 2003.

(51) Int. Cl. H04N 7/025

(52) U.S. Cl. 725/34

(57) ABSTRACT

An “opt-in” based system for displaying targeted content (e.g., advertisements) to a viewer is described. Viewer profiles and content profiles are automatically generated from forms filled out by viewers and content providers, respectively. In a preferred client-based embodiment, content that best matches a viewer profile is downloaded from a server and stored on the corresponding viewer's set top box. When a trigger signifying a content-insertion break (e.g., a commercial break) is detected, locally stored targeted content is selected and displayed to the viewer via the set top box. In a preferred server-based embodiment, content that best matches a viewer profile is embedded in program content and sent to a viewing unit for display to the viewer.

### BACKGROUND OF THE INVENTION

1. Field of the Invention

This invention relates to the field of interactive television, with particular relevance to a targeted content delivery system in an interactive television network.

2. Description of Related Art

Advertising technology for today's television systems is generally inefficient and enables the targeting of content to specific viewers only in very limited ways.

Typically, advertisers using conventional television systems purchase time on programs or channels to deliver their advertisements, and, targeting is limited to the theme or the demographic information associated with the show or channel. For example, research (e.g., Nielsen ratings) may show that a program's audience comprises a large percentage of teenage boys. Advertisers can then target an ad promoting a video game that is popular with teenage boys to this group by buying time on this program. Likewise, in theme targeting, an advertisement for a baseball magazine may be shown during a baseball game broadcast. The main shortcoming of advertising in these conventional systems is that ads are delivered to a program's entire audience rather than being targeted at a specific subset of individuals. These systems may also have the disadvantage of using viewer statistics, which are an unreliable tool for targeting content.

Some sophisticated conventional systems insert advertisements into the program stream at the server end prior to transmission to a viewer. These systems use viewing statistics to determine which commercials to add to a program stream for a viewer. Systems of this type are very complex and cost $300-$500 more per viewer to operate. These systems also have the disadvantage of using viewing statistics, which are an unreliable tool for targeting content.

Other sophisticated conventional systems store targeted ads on a client set top box (STB), perhaps using a digital video recorder (DVR), and then selectively display ads based on a viewer profile that is automatically generated from usage data pertaining to the characteristics of a show whenever that show is being displayed via a STB. The main disadvantage of this system is that the viewer profiles are solely a function of what shows are being displayed via a STB, and, it is difficult to translate this history into an accurate viewer profile, given that these systems do not determine if a show is actually being viewed as it is being displayed. For any number of reasons, a viewer may simply not be watching a show that is being displayed (e.g., falling asleep while watching), or, a TV may simply not be displaying a show being delivered via STB (e.g., because the TV, but not the STB, has been turned off). Thus, these systems are inherently flawed and do not accurately reflect viewer's preferences in the automatically generated viewer profiles. Moreover, these systems also give the network operator (e.g., cable company) no control over which commercials in a broadcasted show can be replaced with a stored targeted ad.

Other sophisticated conventional systems insert ads based only on viewer demographic information. One such system is described in European Patent Application EP 1,067,792 A2 to Stem et al. The Stern application also permits an advertiser to ‘buy time’ by telling a cable provider to display its commercials at a particular house. The advertiser's purchase decision could be based on previous sales by the advertiser to the household or other information unknown to the cable company.

Advertisers using these conventional systems increasingly face a potential problem because of digital video recorders (DVRs). U.S. Pat. No. 6,233,389 and U.S. Pat. No. 6,324,338 describe client devices with functionality typical of present generation DVR's. This functionality includes an interactive program guide, the ability to pause and rewind live television, and the ability to simultaneously playback and record television video content in a simple and accessible manner. DVR's give a viewer a great amount of control over how and when the viewer watches television programs. Crucially, DVRs enable a viewer to fast forward through commercial breaks while viewing a recorded program, or, in the case of live television, to pause the program at the onset of a commercial break, stop viewing the television during this commercial break, and then resume viewing after fast forwarding through the commercial break With the ability to skip over commercial breaks, DVR players make it possible for a viewer never to watch an advertisement. The current, conventional methods of television advertising will no longer be effective as DVR's become increasingly popular, and, accordingly, advertisers will lose revenue. It would be advantageous to improve and add functionality to DVR's and other devices with similar capabilities by providing a system that enables the delivery of accurately targeted ads that both keep the viewer's attention and effectively assist the viewer in making purchasing decisions.

### SUMMARY OF THE INVENTION

The invention provides an “opt-in” system and method wherein targeted content (e.g., an advertisement) is delivered and displayed to a viewer based on the viewer's expressed preferences. This system provides television advertisers with a more effective method of targeting potential customers than current, conventional systems. This system also provides network operators with a more flexible system for working with their advertisers.

The invention may provide a viewing unit that may comprise a conventional digital video recorder (DVR). This device is able to receive and display television program content similar to cable or satellite STBs. In embodiments in which targeted content is inserted on the client side, the viewing unit also provides storage for video content and the ability to replay stored content.

It would be advantageous in some instances to provide control to a viewing unit over which targeted content is displayed. This reduces the need for centralized control and conserves network resources.

In order to better and more efficiently match targeted content such as advertisements, infomercials, and public service announcements to viewer preferences, according to the present invention there is provided a method including identifying a viewer profile for a viewer derived from information provided by the viewer in response to one or more questions; identifying a targeted content profile for a piece of targeted content derived from information about the piece of targeted content; determining a match between the two profiles; and based on the match, selecting the piece of targeted content for display to the viewer.

Forms may be used to obtain viewer preferences. In some embodiments, a viewer completes a form by answering a series of questions. The information found in the completed form may be used to generate a viewer profile that describes the individual's preferences and characteristics. In some embodiments, the viewer profile may be updated over time to indicate changes in the viewer's preferences. Such updates may be based on opt-in or additional statistical information.

In some embodiments, pieces of targeted content may be stored on a targeted content server. Profiles representing the characteristics of targeted content (i.e. an advertisement) and the type of individual it is targeted to may be generated, possibly from forms and possibly in a similar manner as viewer profiles. Ad profiles and viewer profiles may be compared and the best matching content may be downloaded to the viewing unit.

In an embodiment in which a viewing unit determines targeted content to be displayed, a trigger in the incoming or stored program content indicates that a break in program content is arriving and that at least one stored piece of targeted content is to be displayed. A piece of targeted content that matches the viewer profile is then determined and displayed to the viewer. An advantage of this client-based embodiment is that the viewer's characteristics, interests, habits, etc., do not need to leave the viewer's premises.

The present invention provides for various ways to deliver targeted content across a delivery network for display to a viewer. In some embodiments, all targeted content provided by a system operator will be broadcast to all viewing units. Each viewing unit will select which targeted content to store, and which targeted content to display. In some embodiments, the system operator will determine which targeted content to display to which viewers at which times, and embed them in program content. In some embodiments, targeted content will be multicast or unicast to selected viewing units for storage and/or display.

Other features and advantages of the invention will become apparent in the following description of a preferred embodiment along with accompanying figures.

### BRIEF DESCRIPTION OF FIGURES/DRAWINGS

FIG. 1 is a block diagram of a preferred-embodiment of the invention comprising a cable headend, a targeted content server, a STB, and a television.

FIG. 2 is a block diagram of a STB embodiment of a viewing unit that could be used in this system.

FIG. 3 shows an example of a tree structure that can be used to store and categorize attributes of shows, viewers, channels, and targeted content such as advertisements.

FIG. 4 shows an example of a tree.

FIG. 5 shows a category sub-tree that may be used to define and group the characteristics stored in the system.

FIG. 6 shows a flowchart that describes one way to generate profiles.

FIG. 7 shows an example of a form that may be filled out and be used to generate a profile.

FIG. 8 illustrates an example of a data stream of broadcast or stored program content.

FIG. 9 illustrates an example of a commercial break broken into time segments.

FIG. 10 shows an example of a STB for use with the STB embodiment shown in FIG. 2.

### DETAILED DESCRIPTION OF THE PREFERRED EMBODIMENTS

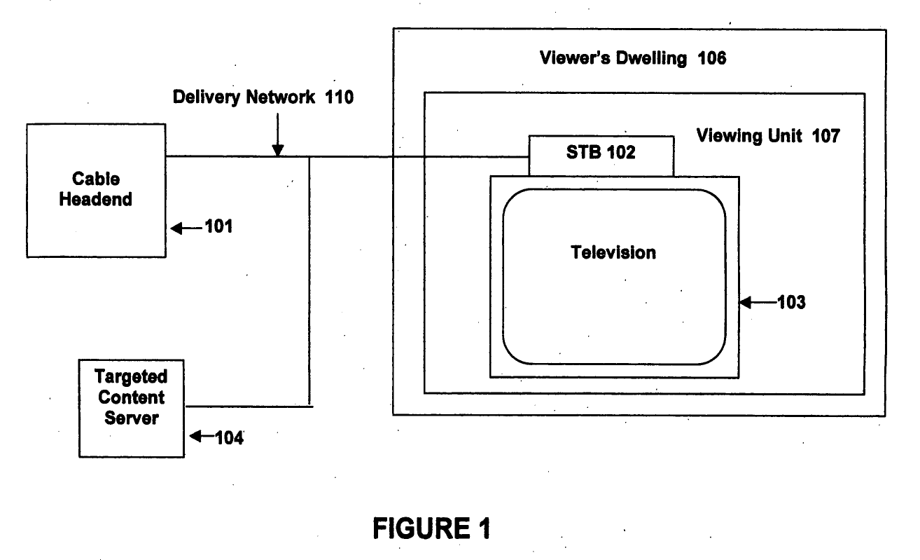

FIG. 1 shows a system-level view of a preferred embodiment of the invention. A cable headend 101 transmits a plurality of program content (e.g., television shows and movies) by broadcasting television or other content signals over a delivery network 110, typically a hybrid coaxial fiber network, to the customer's dwelling 106. A viewing unit 107 receives the television broadcast signals, processes the signals, possibly using a STB 102 including a DVR, and displays program content to a television or other display unit 103 for display. A PC and monitor could be used in viewing unit 107 to provide the functionality of STB 102 and display unit 103, for example, when receiving streaming media delivered over the Internet. Also, in some embodiments, a home-gateway server could be used to provide the functionality of STB 102. Other technical implementations of viewing unit 107 could be used, including other media clients instead of STB 102, as would be apparent. For example, a media gateway could be used that transcodes between video and meta formats, distributes/routes content to different devices within dwelling 106, and performs security and other operations. A targeted content server 104 is used to store targeted content. This content is typically advertisements, and can be directly downloaded from targeted content server 104 to the viewing unit 107 over delivery network 110.

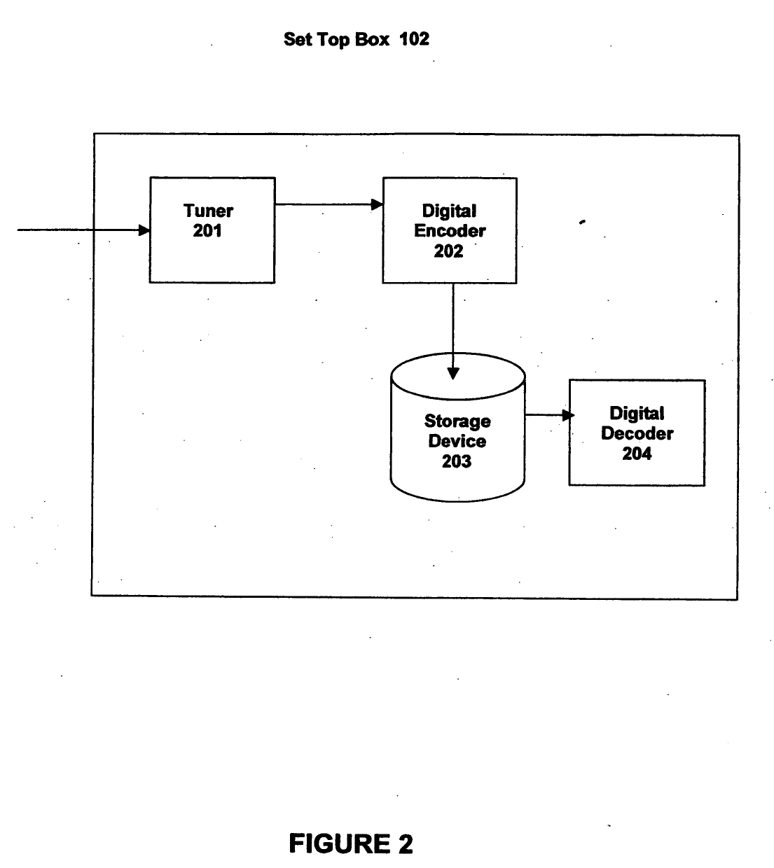

FIG. 2 shows a STB 102 of a preferred embodiment in which viewing unit 107 comprises STB 102. STB 102 receives said broadcasted television signals and a tuner 201 selects/tunes to a specific signal. In the case of an analog signal, the tuned signal is converted into a digital format (e.g., MPEG2), by a digital encoder 202 to be stored on storage device 203, which typically comprises a magnetic hard disk. In the case of a digital signal, the received signal can be stored directly to storage device 203. The stored digital signal may then be decoded into an analog signal by digital decoder 204 for playback. The analog signal may then be outputted to a television or other device for display of the program content corresponding to the signal.

In some embodiments, STB 102 also provides an interactive program guide (IPG) to navigate through received channels. Data associated with television shows is transmitted to STB 102 for the IPG. This data may include information such as time of broadcast and show theme (e.g., sports, cartoon, and law drama).

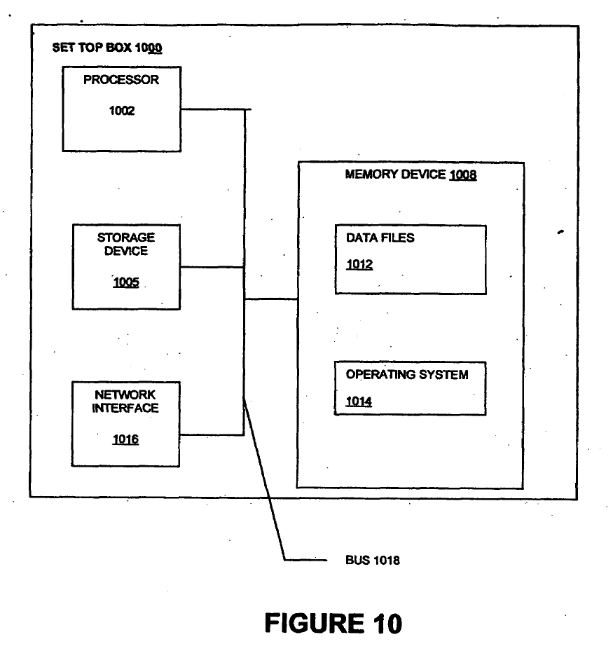

In the preferred, STB-based embodiment illustrated in FIG. 10, STB 102 includes a processor 1002 operatively coupled via a bus 1018 to a memory device 1008, a storage device 1005, and a network interface 1016. Storage device 1005, contains some computer readable medium (e.g., a CD-ROM, floppy disk, a hard disc drive or other magnetic media, a tape drive, or an optical disc drive). Storage device 1005 stores programs that can be executed by processor 1002. Also on the storage device 1005 can be stored data files 1012 which can include the data structures of the present invention. The network interface converts information transmitted to it via bus 1018 into a form suitable for transmission over delivery network 110 and vice versa. The memory device 1008 is a temporary store of information and data that is stored in a convenient form for access by processor 1002. For convenience and rapid access by processor 1002, data files 1012 can be stored in memory device 1008.

The targeting of advertisements to viewers in this system is preferably opt-in based, and may use the concepts of forms and profiles and the methods that use them, including profile generation and clustering. Profiles describe the characteristics of advertisements, viewers, programs and channels, and are generated from the information contained in forms. Clustering is a statistical method that is used to compare various profiles.

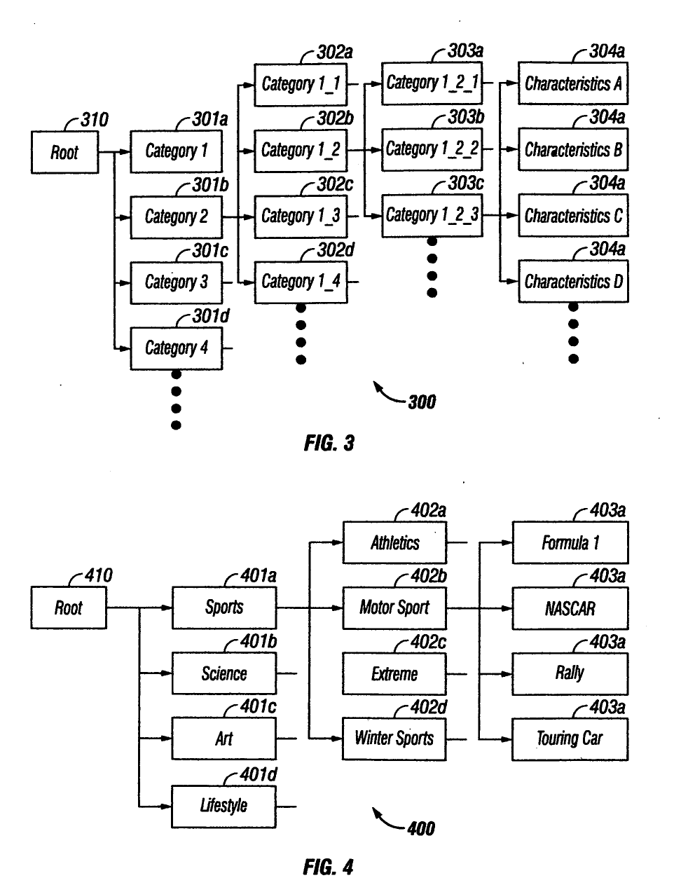

In the preferred embodiment, in order to be able to compare and process the characteristics of viewers, advertisements, programs and channels, a common structure referred to as a category tree is used. An example template for a category tree 300 is shown in FIG. 3. Category tree 300 is a pre-defined, highly detailed, tree-structured scheme for storing attributes in a categorized way. In a STB embodiment, tree 300 could be stored in data files 1012 on memory device 1008, or in storage device 1005, or both. In tree 300, a node, such as nodes 301(a-d), 302(a-d), and 303(a-d), represents a category or a sub-category, while leaves such as 304(a-d) represent characteristics. Tree 300 is a directed tree starting from root 310, going to categories 301(a-d), through layers of sub-categories 302, 303, to leaves 304. In some embodiments, non-directed trees may be used.

FIG. 4 shows an example of a category tree 400 that may be used in this system. The categories shown in tree 400 are sports (node 401a), science (node 401b), art (node 401c), and lifestyle (node 401d.) The subcategories (of category sports) are athletics (node 402a), motor sport (node 402b), extreme (node 402c), and winter sports (node 402d). Leaves in tree 400, under category motor sport, are formula 1 (leaf 403a), NASCAR (leaf 403b), rally (leaf 403c), and touring car (leaf 403d.)

A category tree may define and group characteristics considered in the system. In some embodiments, there are also category sub-trees that represent a subset of characteristics and have a percentage-like value associated with them. In one embodiment, one or more sub-trees may be associated with each of the following objects:
Viewers
Advertisements
Channels
Programs.

Within a system, standard category sub-trees may be defined to determine interest in a certain category or to target an advertisement. In one embodiment, standard category sub-trees include:
Product category: set of characteristics giving the detailed description of a product
Target group: set of characteristics which serve as a base to target an ad
Etc.

For example, in one embodiment, targeted content comprising an ad has a product category sub-tree associated with it that describes the advertised product in detail. It also has a target group sub-tree, which gives the profile of the viewers for whom the ad is targeted. Correspondingly, from the viewer side in this embodiment, a viewer has a product category sub-tree, which indicates how interested the viewer is in that product type (e.g., by specifying a probability), given for every product category in the sub-tree. The viewer also has a target group sub-tree specifying his/her characteristics for targeting content. Other data structures could be used to profile targeted content or viewer information, as would be apparent.

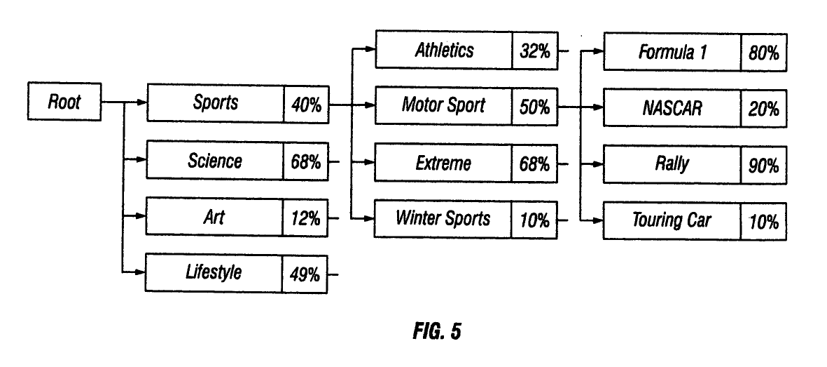

FIG. 5 shows an exemplary category sub-tree 500.

In category sub-tree 500, for every characteristic (leaf or node), there can be a value associated with it, which specifies the grade up to which it characterizes that certain viewer, program, ad, etc. In tree 500, the values used are scalar values expressed as percentages, although, in other embodiments, other values may be used, as would be apparent. In a preferred embodiment (where the tree is represented as a directed graph), each characteristic can get a value in either of two ways: it can have its own value or can obtain a derived value from its children (i.e., those characteristics it points to). A characteristic's value can be derived from its child characteristics' values by, for example, taking their minimum, maximum, or average, or, using another combining function. If a child characteristic's value is not defined, then, in the preferred embodiment, it will not be taken into account in determining it's parent characteristic's value. If no children of a characteristic node has a value, its value in some embodiments will not be defined.

Conversion rules (e.g., min, max, avg.) belong to the structure of a given category tree so they may be pre-defined. The values of characteristics may be calculated dynamically using the rules above, and starting from leaf characteristic values. It is also possible to define a node characteristic value independently of its children's characteristics.

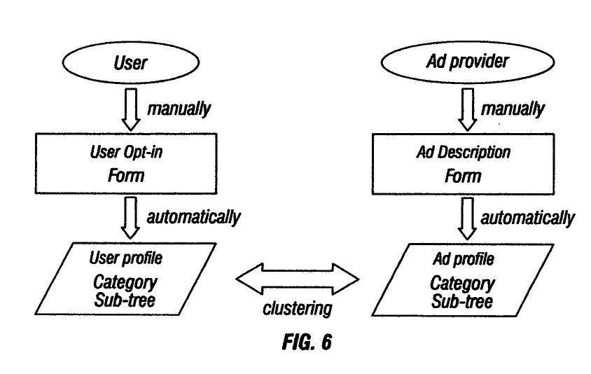

Viewer profiles describe viewer habits and preferences. In the preferred embodiment, the internal representation of a profile is a category sub-tree. Viewer profiles may also be defined as category sub-trees so that the system can compare and match them to targeted content such as ads. Because a category sub-tree is difficult to fill by hand, in the preferred embodiment, opt-in viewer description forms are used to formulate more intuitive, more interesting and briefer questions. In the preferred embodiment, the system, using answers to these questions, builds up the category sub-tree. FIG. 6 depicts a general data flow by which this process is carried out in the preferred embodiment.

FIG. 6 shows a procedure used in a preferred embodiment to determine a match between a viewer and a piece of targeted content. Viewer 601 manually fills out viewer opt-in form 602. This form may be filled out electronically, by hand on paper, or via another suitable medium. Similarly, targeted content provider 604 completes targeted content description form 605 describing a piece of targeted content. This can be done manually (e.g., by a human representative of targeted content provider 604), or automatically (e.g., by a computer using information about the piece of targeted content). If targeted content description form 605 is filled out automatically, it could simply be a data transmission or representation format. Using information from viewer opt-in form 602, user profile 603 may be generated. User profile 603 is preferably represented as a category sub-tree, although it could be represented as other data structures, as would be apparent. Similarly, using information from targeted content description form 605, targeted content profile 606 may be generated. Targeted content profile 606 is preferably represented as a category sub-tree, although it could be represented as other data structures. It is preferable, but not required, for user profile 603 and targeted content profile 606 to be represented as the same general kind of data structure.

After user profile 603 and targeted content profile 606 are generated, they may be compared to determine a measure of similarity between them. In a preferred, STB-based embodiment, such comparison is performed by processor 1002 and user profile 603, and targeted content profile 606 is stored in storage device 1005 or memory device 1008. In one embodiment, if the measure of similarity exceeds a threshold, there is determined to be a ‘match’ between them. The threshold could be predetermined, or it could depend on other information, such as other measures of similarity between various forms. In some embodiments, program content can be described in a program content form, and measures of similarity may be determined between and among program content profiles, targeted content profiles, and viewer profiles (e.g., to determine which targeted content to send, store, or display for which viewers).

In one embodiment, for ease of manual entry, the structure used for forms (e.g., viewer opt-in form 602 and targeted content description form 605) is tree-like, although not limited to the topology of a tree. A form may include questions and/or links to other forms. Possible answers to a question may include, but are not limited to, the following: Boolean (yes/no); Enumerated (with a limited number of choices); Numeric (an integer value); Date; and String.

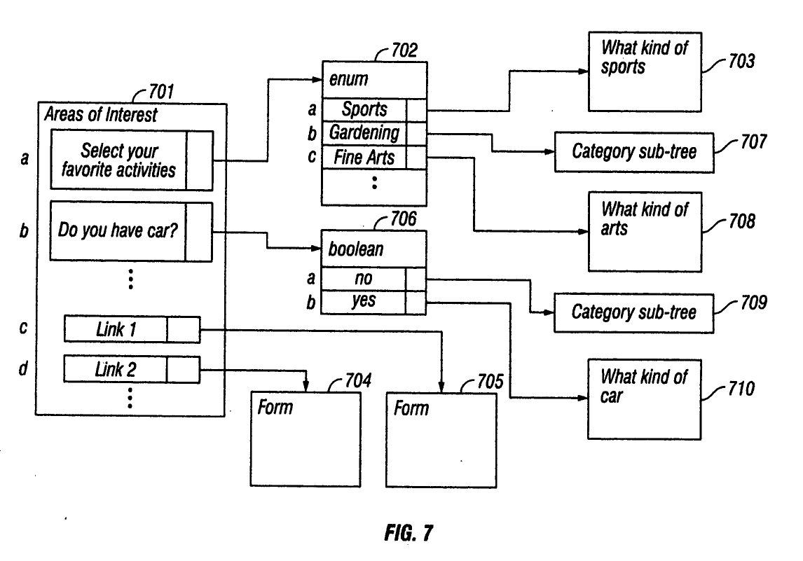

In the case of Boolean and enumerated type questions, other forms may, in some embodiments, be associated with particular choices. These forms can only be accessed if the corresponding answer is selected. An example of an opt-in form is shown in FIG. 7.

FIG. 7 shows a top-level form 701. Question 701a brings up form 702, which allows a viewer to select his or her favorite activities from among a list including (a) sports, (b) gardening, and (c) fine arts. If sports is a favorite activity, form 706 is brought up. If gardening is a favorite activity, form 707 is brought up. If fine arts is a favorite activity, form 708 is brought up. Question 701b brings up form 703, which queries a viewer to indicate whether (s)he has a car or not. Depending on the answer, either form 709 or form 710 will be brought up. Form 701 also contains links, such as link c and link d, which bring up form 704 and form 705, respectively.

The preferred method for generating a category sub-tree from a form is to follow the structure of a form, although other methods may be used, as would be apparent. In the preferred embodiment, for each answer or group of answers in a form, there can be an associated category sub-tree with predefined values. In response to a viewer answer to a question, the values in the associated category sub-tree are added to the generated category sub-tree.

There can only be a fixed number of answers to some of the questions defined in a form, so for these answers or for a group of possible answers (e.g., age groups may be 0-3, 4-9, 10-21, etc.), there can be other forms or pre-defined sub-trees. In the preferred embodiment, when a form gets evaluated, the union of the sub-trees corresponding to the answers given to the forms' questions will build up the final sub-tree. Preferably, in the completed sub-tree, only those nodes that are present in a sub-tree corresponding to an answer will have a value. (For example, if a viewer does not select “fine arts” as a favorite activity, then the arts sub-tree will have no values in it.) The value of a node may be the maximum of the sub-trees corresponding to its answers, or another combining function may be used. The evaluation of a form (i.e., the generation of a profile from a form) is preferably done dynamically from bottom up, first evaluating child nodes and then modifying their parent nodes with their values if it is necessary. The process is repeated until reaching the root node. The result of the process is the form's evaluated (generated) sub-tree.

In the preferred embodiment, each viewer within a household completes a viewer description form, and consequently, a unique viewer profile is generated for each viewer. These profiles are preferably stored both on the viewing unit and the targeted content-server, although in some server-based embodiments a viewer profile may be stored only on the targeted content server, and in some client-based embodiments, a viewer profile may be stored only on the viewing unit. A viewer can update their profile to reflect changes in his/her preferences by completing the same viewer description form or other forms. Additionally, a viewer profile may be created or updated using other information (e.g., statistical), in addition to the information provided by viewer opt-in.

Targeted content profiles describe characteristics of pieces of targeted content. Targeted content profiles are usually simpler than viewer profiles because they generally contain less information. In the preferred embodiment, the internal representations of ad profiles are category sub-trees as well, for reasons of symmetry. For each piece or grouping of targeted content, there is a profile—an evaluated (generated) sub-tree. In the preferred embodiment, this sub-tree is generated upon filling ad description forms, which must be done by the ad provider. In alternative embodiments, the generated targeted content profile may be created by targeted content provider 604 directly, or derived from information other than a form.

Profiles for program content such as shows and channels describe the characteristics of the given program or channel and are also preferably represented internally as category sub-trees. In the preferred embodiment, these sub-trees are be generated from forms using similar techniques as those used to generate ad profiles and viewer profiles. For example, they may be generated from the information found in channel description forms or show description forms. These forms also can be filled out by representatives of the shows/channels. This may include IPG data and Neilson ratings.

Statistical clustering is one matching technique that may be used to find a one-to-many or many-to-one correlation between viewer profiles and targeted content profiles. In the preferred embodiment, targeted content server 104 uses this method to find the most suitable targeted content for a viewer based upon his/her/their profile. To achieve this, the viewer's profile may be compared with the ads' profiles by comparing sub-trees. In the preferred embodiment, the result of the comparison is a percentage-like value, which expresses to what extent the ad fits to the viewer.

There are a finite number of characteristics contained in a category tree, which also defines dependencies between characteristics. A sub-tree is a subset of these characteristics, where each characteristic has its own value. Doing statistical clustering between sub-trees involves the comparison of the two sub-trees. During the comparison of two sub-trees, the component characteristics should be compared. Sub-trees can have different characteristics, so in the preferred embodiment, only the characteristics present in both sub-trees are compared. Preferably, characteristics are weighted via their importance. The result is the weighted average of the similarity of the characteristics expressed in a percentage value.

It is important to consider which sub-tree to compare to which sub-tree. In doing statistical clustering between a viewer and a piece of targeted content, the viewer's sub-tree should be compared to the targeted content's sub-tree. In the preferred embodiment, the following procedure is used. Variations to this procedure, and other procedures, may be used, as would be apparent.

1^{st} Step

Determine the intersection of the two sub-trees (a common sub-tree), which consists of the characteristics that are present in both of them and have some value in each of them. This unified sub-tree will be the object of all further examination. If it is empty, the similarity is 0. Let R be determined as the ratio of the size of the common sub-tree and the piece of targeted content's sub-tree (e.g., the ratio of the number of characteristics in the two sub-trees). If the number of the nodes in the ad's sub-tree is n, and in the common sub-tree is m, then R=m/n. R is a number between 0 and 1, since the nodes in the common sub-tree are contained by the ad's sub-tree (m<=n). R can be used to normalize the measure of similarity to the breadth of interest of the targeted content. Other normalization techniques could be used, as would be apparent.

2^{nd} Step: Weighting

Let the weights corresponding to the nodes of the common sub-tree be determined as follows:
The weight of a leaf node is preferably 1.
The weight of non-leaf nodes is preferably n/m, where n is the number of child nodes corresponding to the node in the common sub-tree, and m is the number of child nodes corresponding to the node in the viewer's sub-tree (i.e., how many child characteristics are involved by the ad and in how many of them is the viewer interested). Because m>=n, the weight is between 0 and 1. This weighting is used to normalize the measure of similarity to the breadth of interest of the viewer. Other normalization techniques could be used, as would be apparent.

3^{rd} Step: Comparison of Nodes

For both of the nodes, there is an associated percentage value, which is between 0 and 1. The two values express how important that characteristic is for the viewer and for the piece of targeted content. For both of them, it is as important as the smaller value. Therefore, in the common sub-tree, the value corresponding to a node is the minimum of this node's values found in the ad's and the user's sub-trees. Of course, other comparison methods could be used (e.g., multiplication, logical values, etc.).

4^{th} Step: Evaluation

In the common sub-tree, there are N characteristics with their e1, e2, . . . , eN values and w1, w2, . . . , wN weights already determined.

The ratio of the similarity of the two sub-trees can be calculated as:

P=((e1*w1+e2*w2+ . . . +eN*wN)/N)*M.

Where P is a number between 0 and 1. The greater the value for P, the more similar the two sub-trees are (i.e., the more suitable the ad is for the user). The factors N and M are used to ensure that P is between 0 and 1. P is a linear measure of similarity. P values could be weighted by other factors (e.g., by preference for a sponsor of targeted content or by a fee level for displaying the content). Also, other linear and nonlinear measures of similarity could be used in place of P values, as would be apparent.

In a server-based embodiment, targeted content server 104 uses measures of similarity such as P-values to determine things such as which viewing units to send targeted content to, which programs to embed which targeted content into, and when to send targeted content. Targeted content can be embedded in program content, or sent separately. It can be sent to particular viewing units or broadcast.

In a client-based embodiment, viewing unit 107 uses measures of similarity such as P-values to determine things such as which targeted content to store, which targeted content to delete, which targeted content to embed in which programs, and which targeted content to display to which users. These determinations are preferably made by processor 1002, which could represent one or more processors depending on the embodiment.

In both client and server based embodiments, other factors besides measures of similarity can be used to determine which targeted content should be sent, stored, deleted, embedded, and/or displayed. These factors include, but are not limited to, fees paid by advertisers or other targeted content sponsors, age-limits on certain targeted content, how many times a piece of targeted content has been displayed to a particular viewer or device, contractual agreements, how much time has elapsed since the last playing of a piece of targeted content, how long a piece of targeted content is, etc.

In a preferred embodiment, pieces of targeted content having a P-value above a certain threshold (e.g., above 60%) are downloaded to the viewing unit. The choice of which targeted content to download to a viewing unit may be made by server 104, by viewing unit 107, or by both. Preferably, targeted content is delivered through delivery network 110 during off peak hours, but it could be delivered at other times and multiplexed with other information. Other descriptive information, such as P-values or other measures of similarity between and among targeted content, program content, and viewers, play length of targeted content, is also downloaded to viewing units. In a preferred, client-based embodiment, each piece of targeted content stored on viewing unit 107 is matched to one or more viewers in dwelling 106 and P-values for each viewer-targeted content match are downloaded to viewing unit 107. Preferably, for storage purposes on viewing unit 107, each piece of targeted content is associated with its corresponding viewer profile and grouped by play-length. All pieces of targeted content having the same play-length are placed into the same group and then are ranked according to their P-values in storage.

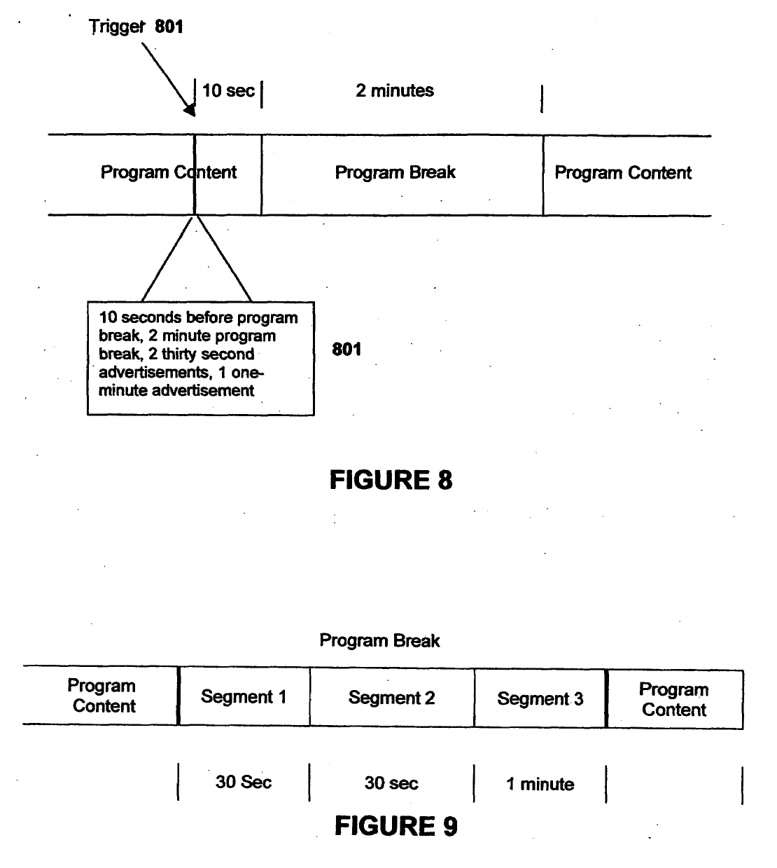

In the preferred, client-based embodiment, displaying stored ads is based on the detection of triggers in the television or other display signals received by viewing unit 107. These triggers can be implemented in a variety of ways and can contain information necessary to display stored ads. The preferred way of sending a trigger is to send a signal such as a pulse at a fixed interval of time before a break, say 15 seconds, and then send additional pulses closer and closer together as the break approaches. Other ways of sending triggers can be used, as would be apparent. Referring to FIG. 8, a trigger 801 is sent, indicating there will be a commercial break (e.g., commercial break begins in 10 seconds), how long the commercial break lasts (e.g., 2 minutes), and, optionally, how many commercials to display (e.g., one 1 minute commercial and two 30 second commercials). In an analog cable system, the trigger information can be inserted into the vertical blanking interval (VBI), or, a technology similar to the Advanced Television Enhancement Forum (ATVEF) specification can be used. In the case of a digital system, data packets containing the triggering information can be inserted into the program datastream. Other methods, data channels, and times of sending triggers, can be used as well.

When a trigger is detected by viewing unit 107, either in a live program being cached on the STB's hard disk or a recorded program being played back, the system extracts the data associated with the trigger. This information is used to determine how many commercials are to be played back and how long each commercial should be. Using this information, the commercial break can be broken into time segments. See FIG. 9.

Unless a viewer logs in or signals somehow or some technology such as facial recognition is used, the profile of the displayed show in which the trigger is embedded (and possibly other information such as channels flipped to, regular viewing habits, the previous show, etc.) is used to determine which viewer (if there is more than one in the household) is currently watching the program, i.e., the active viewer. In the preferred embodiment, the current show's profile is used. Using a measure of similarity such as a if ( P-value, the current show's profile and each viewer profile found on the viewing unit may be compared. The viewer profile that most closely matches the show's profile (e.g., the viewer profile with the highest P-value) is selected as the active viewer profile.

Next, a piece of targeted content such as an ad must be selected. In the preferred embodiment, the highest-ranking available ad (i.e., the ad with the highest P-value) for the active viewer profile that matches the play-length of the current commercial break time segment is selected and played back to the viewer. This process is repeated for each time segment. At the completion of the commercial break, the system returns to displaying the program content.

After an ad is played back, it can be flagged so that a certain number of commercials need to be played back before this specific ad is played again. This prevents the situation where an ad is always selected and displayed repetitiously. Of course, other methods of targeted content selection may be used, possibly including random factors, as would be apparent. Other options worth noting include guaranteeing a minimum number of playbacks or a maximum number of playbacks for an ad. For the former case an ad is not removed from storage or the ranking list until a set number of playbacks has been reached. In the latter case the ad can be removed from the ranking list after a set number of playbacks. This prevents the case where an ad is overplayed and actually turns the viewer off to the product/service being promoted. Of course the cable operator and their agreements with the ad providers determine these options.

The invention provides a way for cable operators to increase revenue. Cable operators can offer advertisers more effective delivery platform. In turn, the cable operators can increase advertising revenue by charging more for this method of targeted ad delivery.

The invention also gives the cable operator greater control over advertising being shown over its network. The use of triggers in the preferred, client-based embodiment allows the cable operator to decide when and how many stored ads are displayed to the user. Stored ads do not need to be inserted in every show that is watched. Triggers to insert and display stored ads can be sent at specific times during specific shows or channels. This gives the cable operator the ability to offer creative and flexible contracts to advertisers.

The specific algorithms and steps described herein, as well as the basic steps which such algorithms represent (even if they are replaced by different algorithms), may in some embodiments be performed using general purpose microprocessors. Furthermore, each of the algorithms and steps described herein, as well as the basic steps represented by such algorithms, may in some embodiments be encoded on computer storage media such as representative storage device 1005.

Although the methods discussed herein have been described in detail with regard to some exemplary embodiments and drawings thereof, it should be apparent to those skilled in the art that various adaptations and modifications of the methods can be accomplished without departing from the spirit and the scope of the invention. Thus, by way of example and not of limitation, the methods are discussed as illustrated by the figures. Variations in the disclosed embodiment are possible without departing from the scope of the invention. Such variations include, but are not limited to, alternative delivery networks and client devices. For example, one skilled in the art can appreciate an embodiment involving large-scale broadcasts or audiovideo-on-demand streaming using RTSP/RTP delivered over the Internet to a viewer's PC that does not depart from the scope of this invention. Also, the functionality of STB 102 could be provided, for example, by a video game system such as Microsoft's XBOX ® system. Such a system would have a hard-drive to store targeted content, a video input for television or other signals, a microprocessor to run code and detect triggers, and a video output to display program content and inserted targeted content. Accordingly, the invention is not limited to the precise embodiments shown in the drawings and described in detail hereinabove, but should only be limited by the following listed claims.

1-39. (canceled)

40. An interactive opt-in viewing unit for targeting advertisements to a viewer based on information provided by the viewer comprising:
means for receiving a viewer profile from the viewer generated by the viewer in response to one or more questions;
means for receiving program content and advertisements;
means for storing received program content, advertisements ,and said viewer profile;
means for determining a match between said received program content and said advertisements based on the viewer generated profile in response to one or more questions; and
means for selecting an advertisement to be displayed to the viewer based on said match whereby the viewer has at least some control over the advertisement displayed to the viewer.

41. The viewing unit of claim 40 wherein said selecting means includes a trigger embedded in said program content.

42. The viewing unit of claim 40 further comprising
means for storing a play-length and a P-value for one of said advertisements.
